(19) United States
(12) Patent Application Publication
(10) Pub. No.: US 2015/0302889 A1
(43) Pub. Date: Oct. 22, 2015

(54) METHOD FOR EDITING MOTION PICTURE, TERMINAL FOR SAME AND RECORDING MEDIUM

(71) Applicant: NEXSTREAMING CORPORATION, Gangdong-gu Seoul (KR)

(72) Inventors: Jae Won CHUNG, Seoul (KR); Kyeong Joong KIM, Seoul (KR); Hyung Seok HAN, Seongnam-si (KR); Kue Ho ON, Seoul (KR); Sung Hyun YOO, Bucheon-si (KR)

(73) Assignee: NEXSTREAMING CORPORATION, Seoul (KR)

(21) Appl. No.: 14/440,692

(22) PCT Filed: Nov. 5, 2013
(86) PCT No.: PCT/KR2013/009932

§ 371 Date: May 5, 2015

(30) Foreign Application Priority Data
Nov. 5, 2012 (KR) 10-2012-0124330

(51) Int. Cl. G11B 27/00; G11B 27/031; G06F 3/0488; G06F 3/0481; G06F 3/0484

(52) U.S. Cl. CPC G11B 27/002; G06F 3/04812; G06F 3/04842; G06F 3/04845; G06F 3/04883; G06F 3/04886; G11B 27/031; G06F 2203/04803

(57) ABSTRACT

Disclosed are a method for editing a motion picture, a terminal for same, and a recording medium. The method for editing a motion picture in a portable terminal having a touch screen and a motion picture editing unit according to one embodiment of the present invention, comprises: a) a step of executing the motion picture editing unit to display a user interface (UI) including a motion picture display region, a progress bar and a clip display region via the touch screen; b) a step of displaying the motion picture to be edited onto the motion picture display region and selecting a start frame and a final frame from among the motion pictures to be edited so as to generate a clip including the frames in the selected region; and c) a step of displaying the generated clip onto the clip display region, and performing at least one motion picture editing by performing clip copy by means of a clip unit, clip order change or clip deletion.

### TECHNICAL FIELD

The present invention relates to a method for editing a moving picture in a portable terminal, the terminal for the same, and a recording medium.

### BACKGROUND ART

Generally, with the development of information communication technology, portable terminals capable of taking moving pictures, such as cellular phones and tablet PCs, are widely used. Also, depending on the advanced performance of the portable terminals and the proliferation of high-speed communication functions, services for sharing moving pictures have increased.

Accordingly, a desire for adapting a moving picture editor, which is used by experts in existing PCs, to a portable terminal and for using it in the portable terminal has been increasing.

As representative moving picture editors, there are various editors including editors having advanced features such as Apple's “iMovie” and simple editors that only provide a function for deleting some frames from the beginning or from the end of a moving picture.

However, because technology for moving picture editors originated with regard to existing PCs, portable terminals have hardware limitations for performing such editing. Also, the functions of many available moving picture editors are too complicated to be used by unskilled users.

Additionally, a portable terminal may have high performance but has a very small screen in comparison with a

PC monitor. Accordingly, it is inconvenient to handle various moving picture editing functions on such a small screen.

Also, to compensate for the inconvenience, a moving picture editor applied to portable terminals has a complex user interface, but the functions of the motion editor are limited to image editing or to cutting frames on a frame basis. Therefore, there is a limit in providing the various functions demanded by users.

A patent document, Korean Patent Application Publication No. 2010-0028344 discloses a method and apparatus for editing an image of a portable terminal.

However, like an existing function for editing pictures, the patent document provides a function in which simple image editing is applied to a moving picture on only a frame basis, thus it is limited in providing various functions desired by users.

### DISCLOSURE

### Technical Problem

An embodiment of the present invention intends to provide a method for editing a moving picture, a terminal for the same, and a recording medium, which provide various functions for editing a moving picture on a clip basis, using a simple user interface (UI) applied to a portable terminal.

### Technical Solution

According to an embodiment of the present invention, a method for editing a moving picture in a portable terminal having a touch screen and a moving picture editing unit, includes: a) displaying a user interface (UI), including a moving picture display region, a progress bar, and a clip display region, on the touch screen by executing the moving picture editing unit; b) displaying an editing target moving picture in the moving picture display region, and generating a clip including frames within a selected section by selecting a start frame and a last frame in the editing target moving picture; and c) displaying the generated clip in the clip display region, and performing at least one moving picture editing function on a clip basis among copying a clip, moving an order of a clip, and deleting a clip.

Also, step b) displays only I-frames of the editing target moving picture and may generate the clip based on the I-frames.

The progress bar may display a time-axis position of a frame in a whole section of the editing target moving picture, using a marker, the frame being displayed in the moving picture display region.

Also, step b) may select the start frame and the last frame through two frame inputs that are performed by selecting a frame displayed in the moving picture display region and by dragging the selected frame to the clip display region.

Also, step b) may include: changing color of a first marker that indicates a position of a first frame and fixing a position of the first marker when the first frame is input, and displaying a second marker for selecting a second frame; and deleting the first marker and generating the clip when the second frame is input.

The first frame is the start frame or the last frame, and the second frame is the start frame or the last frame.

Also, step b) may generate the clip by including frames from the start frame to a frame just before the last frame.

Also, in step b), when the last frame is either a P-frame or a B-frame, a corresponding I-frame used by the last frame may not be included in the generated clip.

Also, step b) may generate a clip that shows a same frame for a certain period of time, by consecutively selecting the same frame.

Also, step b) may generate the clip that shows a same frame for a certain period of time, by selecting the same frame as the start frame and the last frame and then inputting time information between the two frames or inputting the number of frames between the two frames.

Also, step c) may display a frame image of the generated clip using a thumbnail mode, and may display the frame image as a three-dimensional shape of icon that has length information of the clip.

Also, step c) may copy a first clip located in the clip display region or may generate a second clip from a part of frames of the first clip.

Also, step c) may generate multiple clips that share a part of frames.

Also, step c) may include: generating a virtual frame just before the first frame or the right after the last frame of a first editing target moving picture that is displayed in the moving picture display region; and connecting a second editing target moving picture right before the first frame or right after the last frame by loading the second editing target moving picture through the virtual frame.

Here, at least one among the first editing target moving picture and the second editing target moving picture may be the clip.

Also, after the step for connecting the second editing target moving picture, reconstructing a progress bar based on the connected first editing target moving picture and second editing target moving picture may be further included.

Also, after the step for connecting the second editing target moving picture, either generating a clip by joining the first editing target moving picture and the second editing target moving picture; or generating a clip covering a part of the first editing target moving picture and a part of the second editing target moving picture may be further included.

Also, step c) performs a preview step before generating a moving picture that includes multiple clips, and may provide a search function for each of the clips.

According to an embodiment of the present invention, a portable terminal, which stores a program implementing any one of the above-described methods, or in which a recording medium storing the program can be mounted may be provided.

According to an embodiment of the present invention, a recording medium in which a program for implementing any one of the above-described methods is stored may be provided.

### Advantageous Effects

According to the embodiment of the present invention, a function for editing a moving picture is provided not on a frame basis but on a clip basis, thus it is possible to edit various moving pictures in a portable terminal.

Also, because an intuitive and easy-to-use user interface is provided for clip-basis moving picture editing, user convenience can be improved when performing moving picture editing on a portable terminal having a limited screen size.

Also, because a clip moving picture is generated based on I-frames to edit a moving picture, unnecessary encoding and decoding can be skipped and moving picture editing can be performed quickly.

### DESCRIPTION OF DRAWINGS

FIG. 1 illustrates information of moving pictures by a unit of I-frames, P-frames, and B-frames, and a predicted direction on each of the frames according to an embodiment of the present invention;

FIG. 2 is a block diagram schematically illustrating a portable terminal according to an embodiment of the present invention;

FIG. 3 illustrates a UI layout provided in a moving picture editing unit according to an embodiment of the present invention;

FIG. 4 illustrates clip presentation examples according to an embodiment of the present invention;

FIG. 5 illustrates a process for generating a clip using a UI according to a first embodiment of the present invention;

FIG. 6 illustrates a configuration of frames of an actual clip that is generated from two frames according to a first embodiment of the present invention;

FIG. 7 is illustrates a configuration of frames, which is applied to an actual clip, when a P-frame is selected as a last frame according to a first embodiment of the present invention;

FIG. 8 illustrates a method for generating a clip using a UI according to a second embodiment of the present invention;

FIG. 9 illustrates various forms of generated clips according to an embodiment of the present invention;

FIG. 10 illustrates a process for displaying multiple moving pictures in a moving picture display region according to a third embodiment of the present invention;

FIG. 11 illustrates various clip generation methods using multiple moving pictures according to a third embodiment of the present invention;

FIG. 12 illustrates an array of clips before and after clip B is long pressed according to an embodiment of the present invention;

FIG. 13 illustrates a view just before copying is performed when clip B is long pressed according to an embodiment of the present invention;

FIG. 14 illustrates an example of the deletion of a clip according to an embodiment of the present invention; and

FIG. 15 illustrates a method for displaying whether a hidden clip exists in a clip display region according to an embodiment of the present invention.

### BEST MODE

Reference will now be made in greater detail to exemplary embodiments of the present invention, examples of which are illustrated in the accompanying drawings. The exemplary embodiments described hereinafter are provided for fully conveying the scope and spirit of the invention to those skilled in the art, so it should be understood that the embodiments may be changed to a variety of embodiments and the scope and spirit of the invention are not limited to the embodiments described hereinafter. Wherever possible, the same reference numbers will be used throughout the drawings to refer to the same or like parts of which redundant details shall be omitted.

In the present specification, it should be understood that terms such as “include” or “have” are merely intended to indicate that components are present, and are not intended to exclude a possibility that one or more other components, will be present or added. Also, in the specification, “unit”, “part”, “module”, “device”, or the like, means a unit for performing at least one function or operation, and can be implemented by hardware, software, and/or a combination thereof.

Now, a method for editing a moving picture, a terminal for the same, and a recording medium according to an embodiment of the present invention are described in detail referring to the drawings.

First, to understand functions for editing a moving picture according to an embodiment of the present invention, it is necessary to understand the frame structure that forms a moving picture.

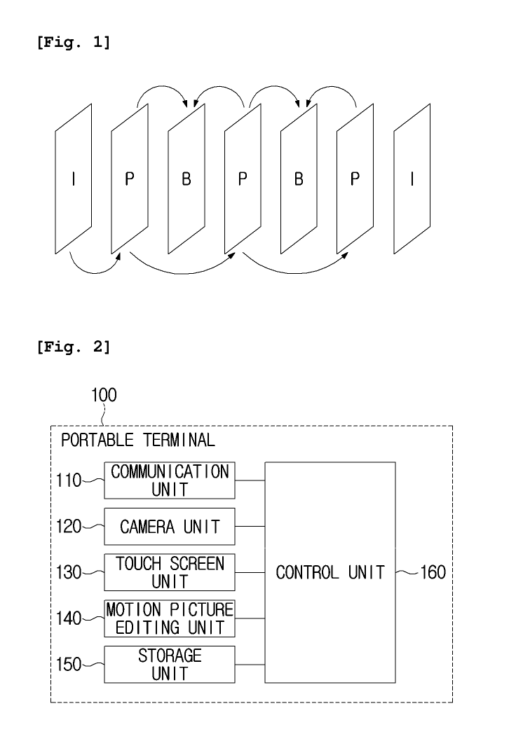

FIG. 1 illustrates information of moving pictures by a unit of I-frames, P-frames, and B-frames, and a predicted direction on each of the frames.

Referring to FIG. 1, multiple frames forming a moving picture are sequentially arranged, and the multiple frames are composed of I-frames, P-frames, and B-frames.

As a moving picture has a large amount of information, encoding is performed to encrypt and store the information. To play the stored moving picture, the encrypted information is reconstructed for each of the frames through decoding and then displayed on a screen.

The encoding and decoding is performed for each of the frames, and a predictive coding method is typically used as a moving picture compression method, in which prediction is performed using adjacent information and only the difference between an actual value and a predictive value is sent.

Here, the frame in which information only exists in the same frame without adjacent information used for prediction is called Intra Frame (I-frame); the frame that only uses information of the directly preceding (previous) frame of the current frame is called Predictive Frame (P-frame); and the frame that uses both the directly preceding (previous) frame and the directly following (next) frame of the current frame called Bi-directional Predictive Frame (B-frame).

As a frame has more adjacent information, which is used for prediction, the prediction is more accurate and the compression rate is higher, and accordingly, the compression rate according to a frame type becomes lower in the following order: B-frames>P-frames>I-frames. In other words, I-frames have the lowest compression rate and have high bit rates in comparison with P-frames and B-frames.

FIG. 2 is a block diagram schematically illustrating a portable terminal according to an embodiment of the present invention.

Referring to FIG. 2, a portable terminal 100 according to an embodiment of the present invention is an information communication device such as a cellular phone, a tablet PC, a Personal Digital Assistant (PDA), and the like. The portable terminal 100 includes a communication unit 110, a camera unit 120, a touch screen unit 130, a moving picture editing unit 140, a storage unit 150, and a control unit 160.

The communication unit 110 performs wireless communication such as 3G, 4G, Wi-Fi, and the like, using an antenna, and supports application services such as sharing moving pictures, etc., through Internet access.

Depending on the manipulation by a user, the camera unit 120 takes pictures and moving pictures and stores them in the storage unit 150.

The touch screen unit 130 displays information according to an operation of the portable terminal 100 on a screen, and receives a command depending on a touch by a user.

Especially, the touch screen unit 130 according to an embodiment of the present invention may present on a screen a user interface (hereinafter referred to UI) that can be intuitively and easily used compared to an existing moving picture editing technique. Also, to execute a function for editing, the touch screen unit 130 recognizes user inputs including a long press, a drag, a single tab, a double tab, and the like.

Here, the long press indicates an input action when a user presses a specific point on a screen for a certain period of time; the drag indicates an input action when a specific point on the screen is pressed by a user's finger while moving his/her finger; the single tab indicates an input action by slightly touching a specific point on a screen once; and the double tab indicates an input action by slightly touching a specific point on a screen twice quickly.

Existing moving picture editors have a complicated UI but the function is limited to simply cutting the moving picture, whereas the moving picture editing unit 140 provides a touch-based UI that provides simple and various moving picture editing functions to enable a user to intuitively and easily manipulate the functions. The UI will be described in detail later.

The moving picture editing unit 140 generates from an editing target moving picture, at least one clip that includes frames from a start frame to a final frame. Then, the moving picture editing unit 140 can perform various moving picture editing functions such as copying a clip, moving an order of clips, deleting a clip, and the like, on the generated clip basis.

Here, the clip means a section of a moving picture (that is, a plurality of frames) selected by a user in the editing target moving picture.

To present a clip, the moving picture editing unit 140 shows a representative frame included in the clip as a thumbnail picture in a portion of a screen. Then, editing is performed on a clip basis by manipulating the thumbnail picture that is displayed as an icon format.

The moving picture editing unit 140 is installed in a portable terminal 100 as a default option before the portable terminal is launched, or can be installed as an application program by being provided through an online or offline supply chain.

The storage unit 150 stores moving pictures directly taken by the camera unit 120 or moving pictures received from an external device or Internet, and stores a program for editing and playing moving pictures.

Also, the storage unit 150 may store a clip generated by operations of the moving picture editing unit 140, and a moving picture generated through editing on the clip basis.

The control unit 160 controls the operation of each of the units to operate the portable terminal 100, and executes the moving picture editing unit 140 for editing a moving picture on a clip basis according to an embodiment of the present invention.

Hereinafter, referring to the accompanying drawings, a layout of a user interface (UI), which is provided for editing a moving picture on a clip basis by a moving picture editing unit 140 of a portable terminal 100 according to the above-described embodiment of the present invention, and a method for generating a clip and editing a moving picture on a clip basis, which is performed through the UI, are described in detail.

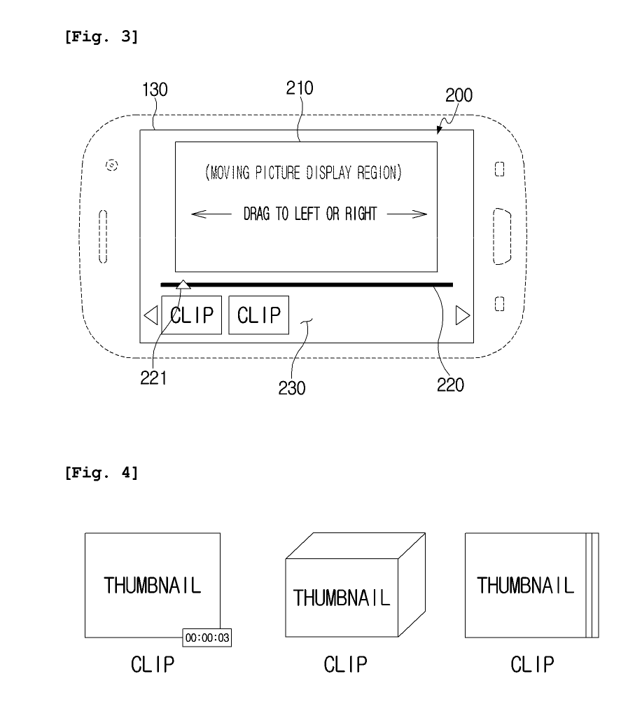

FIG. 3 illustrates a UI layout provided in a moving picture editing unit according to an embodiment of the present invention.

Referring to FIG. 3, the UI 200 according to an embodiment of the present invention includes a moving picture display region 210, a progress bar 220, and a clip display region 230. Here, the detailed configuration of the UI 200 is described by the displayed components such as a region or a bar, but the components can be configured as a module that executes its own function or a related function to edit a moving picture.

To select a single frame in an editing target moving picture, the moving picture display region 210 displays frames sequentially depending on a left/right drag input.

Here, the selection of the frame means that a range is set (input) to generate a clip that will be described later and the selected frame can be input by dragging a view of the frame, which is displayed in the moving picture display region 210, to the clip display region 230. For example, like the UI layout of FIG. 3, when the clip display region 230 is presented on the bottom of the screen, the selected frame can be input by dragging it to the bottom.

To permit a user select only I-frames, the moving picture display region 210 displays only I-frames on the screen when the user selects a frame in an editing target moving picture.

When the frame is selected based on I-frames, a new moving picture can be generated by only bit manipulation of the corresponding clip and encoding/decoding is not necessary, thus speed can be improved in editing the moving picture.

The progress bar 220 can show a time-axis position of a frame, which is displayed in the moving picture display region 210, in a whole section of the editing target moving picture, using a marker 221.

Also, when the frame is selected in the moving picture display region 210, the progress bar 220 can present a process in which a start frame and a final frame are selected, using the marker 221. This will be described later in detail in the description of a method for generating a clip.

The clip display region 230 binds multiple frames, which are selected in the moving picture display region 210 to generate a clip, and shows it in a clip. In this case, the clip is displayed like an icon by forming a thumbnail from an image of a specific frame (for example, the first I-frame), and the length of the clip can be displayed on the icon.

For example, FIG. 4 illustrates clip presentation examples according to an embodiment of the present invention.

Referring to FIG. 4, clip A, clip B, and clip C can display a thumbnail, and each of the clips includes a different form of length information.

Clip A shows a general thumbnail mode and the playing time is included in the thumbnail, but it is less intuitive because the playing time is displayed in a small size in the portable terminal 100 that has a smaller screen than a PC.

Consequently, to enhance intuitiveness, the size of the clip, such as the playing time or the number of frames, is displayed as the thickness of a three-dimensional figure that can indicate a predetermined level, like clip B, or the size of the clip is displayed as the different amount of accumulated frames (rectangles), like clip C.

Such a visual composition of a clip not only displays a moving picture using a thumbnail but also enables a user to relatively compare multiple clips, for example, which clip is long or which clip is short. Therefore, the presentation of the clip may provide important information that can be referred to in an editing process.

Also, the clip display region 230 can arrange multiple clips depending on an order that the multiple clips are generated or the position of the clips in the editing target moving picture.

Hereinabove, the UI layout provided in the moving picture editing unit 140 is simply described. However, not limited to the above-description, functions not mentioned in the above description are described in the description of a method for generating a clip and editing a moving picture on a clip basis.

A method in which a clip is generated by a moving picture editing unit 140 according to an embodiment of the present invention is described.

As described above, the moving picture editing unit 140 provides a UI for generating a clip through a touch screen unit 130, and generates a clip by receiving multiple frames that are selected by a user.

In this case, a method for generating a clip is divided into two embodiments as follows.

### First Embodiment

Through a UI, the moving picture editing unit 140 receives a first frame and a second frame, which the user wants to store as a clip in an editing target moving picture, and generates a clip that includes pictures between the first frame and the second frame.

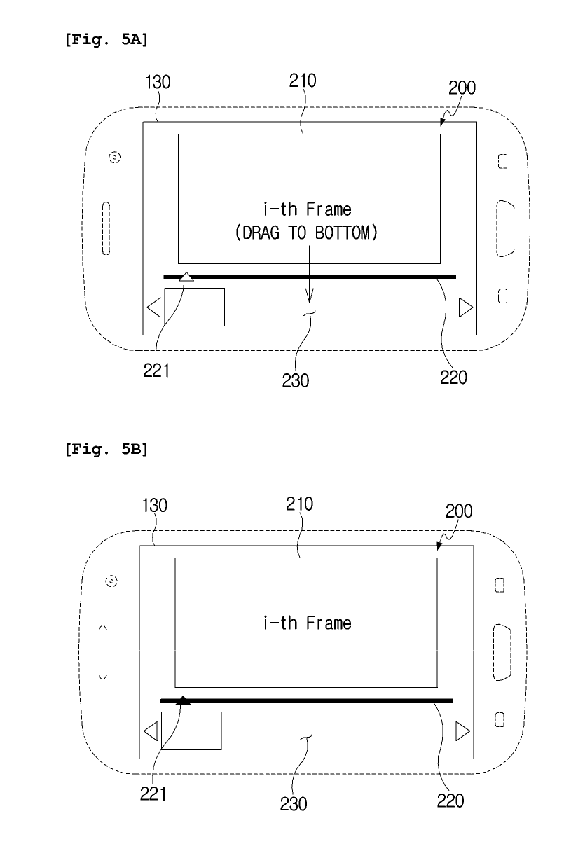

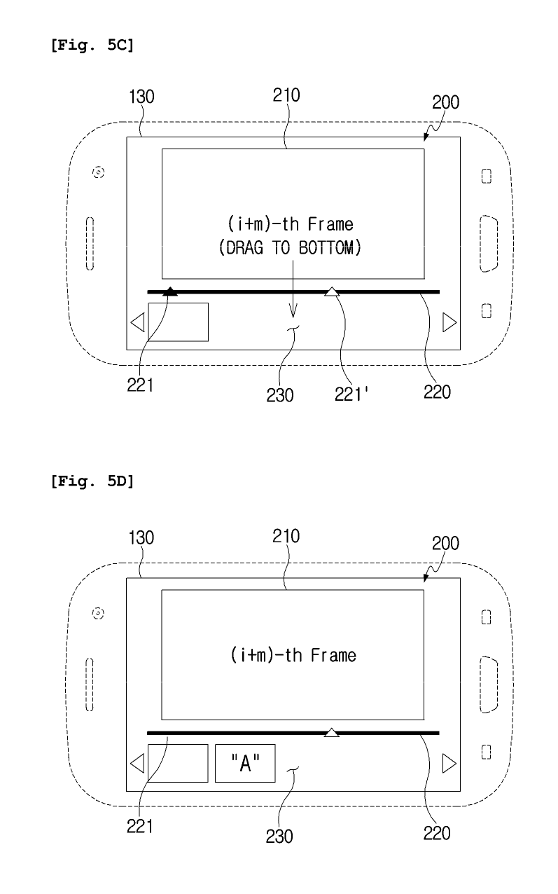

FIG. 5 illustrates a process for generating a clip using a UI according to a first embodiment of the present invention.

Referring to FIG. 5, in the case of a moving picture clip, because first and last frames of a clip should be determined, the selection of the frame is required two times to generate the clip, FIGS. 5a to 5d illustrate a process for selecting first and last frames, using a marker 221 of a progress bar 220.

FIG. 5a shows a step in which a user selects and inputs a first frame (i-th Frame) in the moving picture display region 210.

The maker 221 of the progress bar 220 is displayed in white color in an initial state in which a frame has not been input.

At this time, when the user selects the first frame (i-th Frame) for generating a clip and drags it to the bottom in which the clip display region 230 is arranged, the moving picture editing unit 140 recognizes that the first frame (i-th Frame) is input.

FIG. 5b shows the marker 221 of the progress bar 220 is changed to black color after the first frame for generating a clip is input.

In this case, the maker 221 that is changed to a black color indicates that the first frame is normally input, and represents the standby state waiting for the input of the second frame.

FIG. 5c shows a step in which the user selects and inputs the second frame ((i+m)-th Frame) in the moving picture display region 210.

At this time, the position of the first marker 221 that has changed into black is fixed, and a white second marker 221′ for selecting the second frame is presented.

Then, when the user selects the second frame ((i+m)-th Frame) for generating a clip and drags it to the bottom in which the clip display region 230 is arranged, the moving picture editing unit 140 recognizes that the second frame ((i+m)-th Frame) is input and can generate clip “A” that includes frames between the two frames.

FIG. 5d shows that the marker 221′ of the progress bar 220 is displayed in white after the clip is generated by inputting the second frame.

In other words, as shown in FIG. 5c, when the second frame for generating a clip is input, the black first marker 221 disappears and only the white second marker 221′ remains.

In the first embodiment with reference to FIG. 5, the second selected frame is positioned after the first selected frame on the time axis of the editing target moving picture, however, not limited to the above description, the last frame can be selected first and then the start frame can be selected second.

In other words, the first selected frame does not necessarily become the start frame and it may be the start frame or the last frame, likewise, the second frame may be the start frame or the last frame.

As mentioned above, when a clip is generated through the two drag inputs, the first frame and the second frame of the generated clip is irrelevant to the order thereof in the editing target moving picture, which is advantageous in moving picture editing.

Also, in FIG. 5, the color and shape of the marker 221 are not limited to black or white and a triangle shape, and various shapes can be applied to differently display the process for selecting a frame.

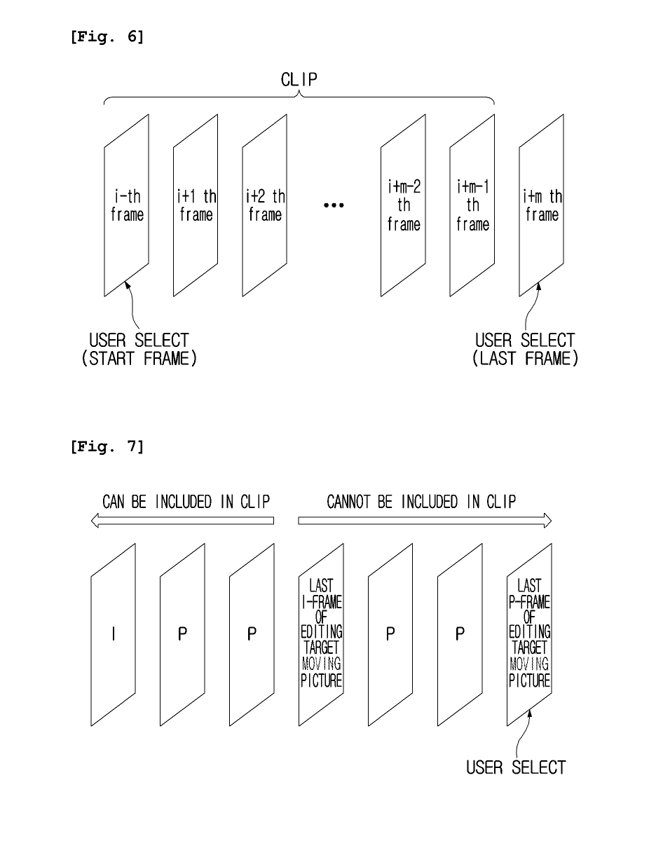

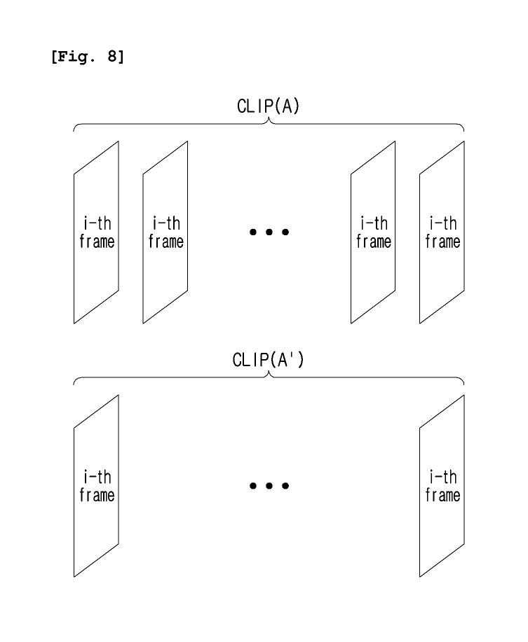

FIG. 6 illustrates a configuration of frames of an actual clip that is generated from two frames according to the first embodiment of the present invention.

Referring to FIG. 6, when the start frame (i-th Frame) and the last frame ((i+m)-th Frame) are input depending on selection by a user, the moving picture editing unit 40 does not include the last frame ((i+m)-th Frame), which is placed at the hindmost part on the basis of the editing target moving picture, in the clip, and effectively includes frames just before the last frame. In other words, the last frame ((i+m)-th Frame) is excluded from the clip.

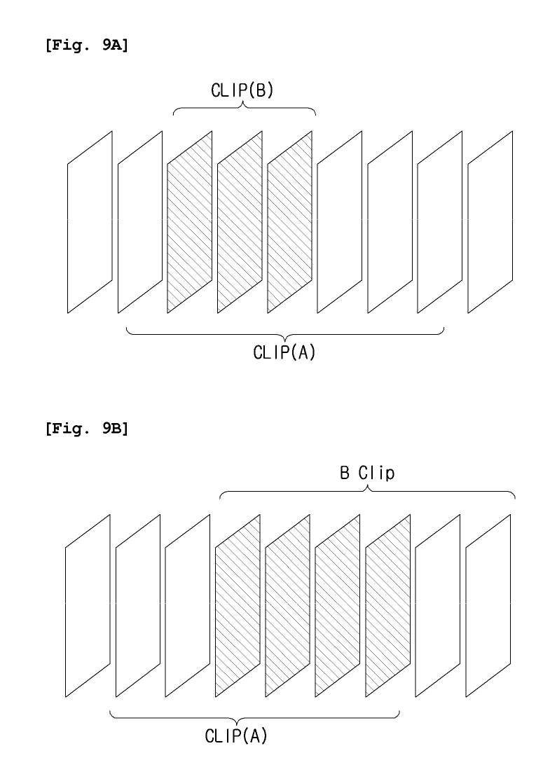

Also, FIG. 7 illustrates a configuration of frames applied to an actual clip when a P-frame is selected as the last frame according to the first embodiment of the present invention.

Referring to FIG. 7, when a frame is selected to generate a clip, the last frame of an editing target moving picture may be a P-frame. In this case, if the frame is selected based on an I-frame, frames from the last I-frame to the P-frame that is the last frame of the editing target moving picture are not included in the newly edited clip.

As mentioned above, the reason why the last frame based on an I-frame is excluded from the clip in FIGS. 6 and 7 is to generate a clip based on I-frames for any moving pictures, whereby the speed can be improved in editing the moving picture.

### Second Embodiment

By consecutively selecting the same frame, the moving picture editing unit 140 may generate a clip in which the corresponding frame is displayed for a certain period of time. In this case, the generated clip has an effect similar to a slow motion when the clip is played.

FIG. 8 illustrates a method in which a clip is generated using a UI according to the second embodiment of the present invention.

As mentioned above, in the first embodiment, the method in which a clip is generated by selecting two different frames is described. Referring to FIG. 8, in addition to the method, a clip having a plurality of the same frames can be generated by repeatedly selecting the same frame, like clip A. In other words, the simplest method for continuously displaying the same picture is a method in which a clip is composed of a number of the frames that correspond to the picture and are repeatedly displayed.

However, if the selected frame is an I-frame, a bit rate of each of the same frames is high. Therefore, the size of the generated clip A can be large.

Accordingly, instead of sending all of the bits of the repeated I-frame to show a user the same picture, it is possible to decrease the bit rate like clip A′ by inputting bits of the first I-frame, bits of the last I-frame, and time information for which the clip is played.

In other words, like clip A′, to decrease the bit rate, only the selected first and last i-th frames are used, and time information between the two frames or the number of frames between two frames is input.

Consequently, if the selected frame is an I-frame, it is possible to drop the bit rate of the repeated I-frame, thus sharply reducing the data amount of the generated clip.

FIG. 9 illustrates various forms of generated clips according to an embodiment of the present invention.

First, referring to FIG. 9a, clip A and clip B are independently generated, but clip B can be generated from some frames of clip A.

Also, referring to FIG. 9b, clip A and clip B are separately generated, but some frames of clip A and clip B can be shared.

In other words, one characteristic of a method for editing a moving picture on a clip basis according to an embodiment of the present invention is considering that a part of any one clip among the multiple clips may be the same as a part of another clip as shown in FIG. 9a, or that a part of a clip is the same as another clip.

Such a characteristic is an important advantage of the present invention, in which the moving picture editing unit 140 generates a clip and editing is performed based on the clip. Also, it is different from existing editors in that existing editors based on editing a target moving picture cannot provide such various editing functions.

The generated clips through the above-described first and second embodiments are arranged in the clip display region 230. The arranged clips can be displayed using a simple mark, for example, a number or a letter, and a specific frame of the clip can be displayed as a thumbnail.

Furthermore, by displaying the clip through various presentations described in FIG. 4, the moving picture editing unit 140 that includes functions such as selectively moving, copying, and deleting a clip on the screen enables a user to recognize a clip and to select a function intuitively and easily in spite of the limited screen size of a portable terminal.

### Third Embodiment

According to the third embodiment, a method in which a moving picture editing unit 140 edits a moving picture on a clip basis using a generated clip is described.

The moving picture editing unit 140 generates a virtual frame before the first frame and after the last frame of an editing target moving picture that is displayed in the moving picture region 210. When the virtual frame is selected, a menu option for loading a new moving picture or a clip is provided to display various moving pictures that become a target to edit.

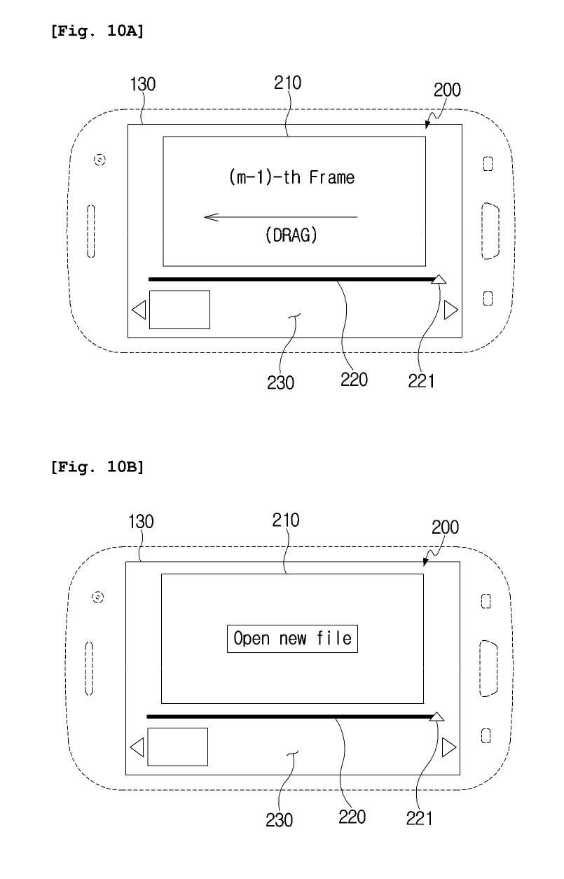

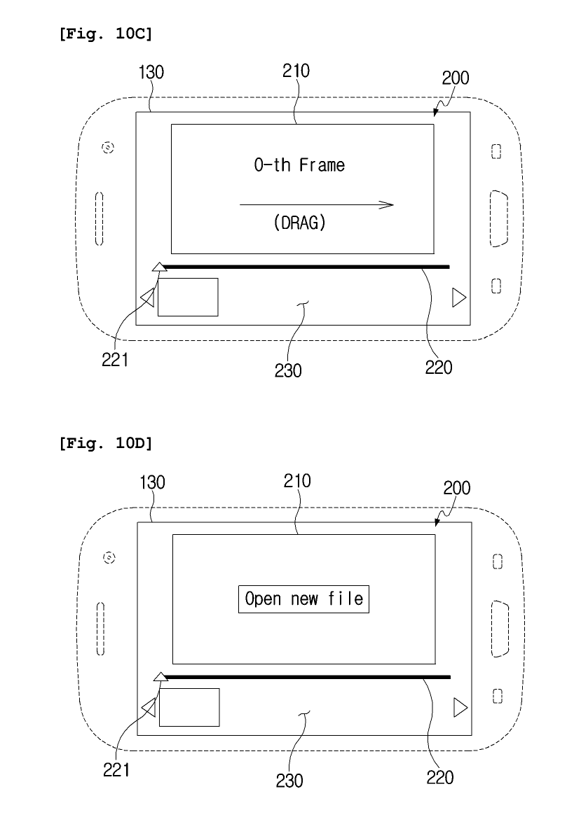

FIG. 10 illustrates a process for displaying multiple moving pictures in a moving picture display region according to the third embodiment of the present invention.

Referring to FIGS. 10a and 10b, when a first editing target moving picture composed of m number of frames (0-th Frame-(m−1)-th Frame) is displayed in the moving picture display region 210 according to the embodiment of the present invention, a second editing target moving picture is loaded and displayed after the last frame ((m−1)-th Frame).

Here, the second editing target moving picture may be a clip that is generated according to the embodiment of the present invention.

While frames are sequentially displayed to select a frame from the first editing target moving picture that is displayed in the moving picture editing region 210, when a view of the last frame ((m−1)-th Frame) is dragged to the left as shown in FIG. 10a, a virtual frame of FIG. 10b is displayed to enable selecting a new editing target that is a second editing target moving picture or a clip.

Likewise, referring to FIGS. 10a and 10b, while frames are sequentially displayed to select a frame from the first editing target moving picture that is displayed in the moving picture editing region 210, when a view of the first frame (0-th Frame) is dragged to the right as shown in FIG. 10c, a virtual frame of FIG. 10d is displayed to enable selecting a new editing target that is a second editing target moving picture or a clip.

When the moving picture editing unit 140 additionally loads an editing target moving picture through the virtual frame and displays the multiple editing target moving pictures in the moving picture editing region 210, a progress bar 220 can be reconstructed based on the multiple editing target moving pictures.

Also, when selecting a different moving picture through the virtual frame, the moving picture editing unit 140 checks in advance whether the moving picture file can be joined to the current file and displays only the file that can be joined. This is advantageous when a clip based on I-frames, which do not require encoding/decoding, is generated

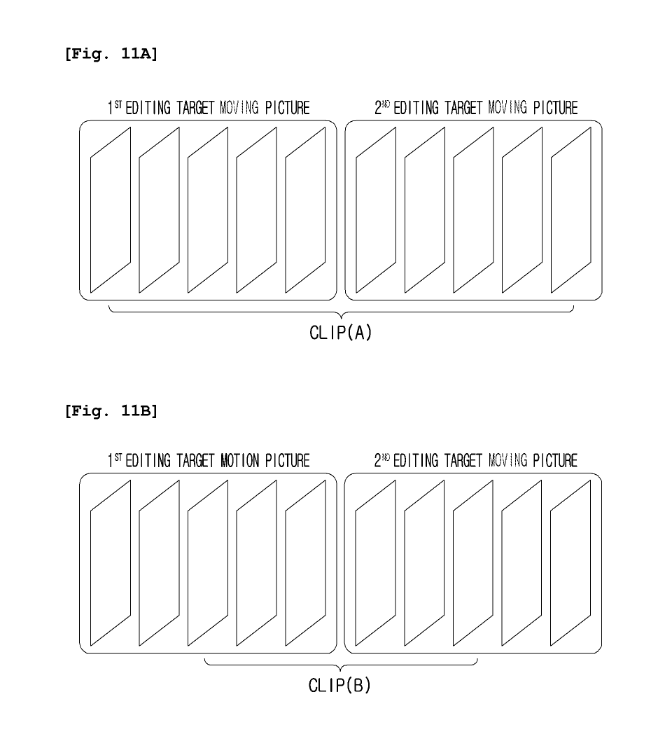

FIG. 11 illustrates various clip generation methods using multiple moving pictures according to the third embodiment of the present invention.

A moving picture editing unit 140 according to the third embodiment of the present invention can bind multiple editing target moving pictures that are displayed in the moving picture editing region 210 and store them as a single clip. Also, using the same method as the method for generating a clip from one moving picture, the moving picture editing unit 140 can generate a clip that includes a part of each of the multiple moving pictures displayed side by side.

First, referring to FIG. 11a, the moving picture editing unit 140 connects two different editing target moving pictures and displays them in a line in the moving picture display region 210, and may newly generate a single clip A by joining the two moving pictures.

Also, referring to FIG. 11b, the moving picture editing unit 140 connects two different editing target moving pictures and displays them in a line in the moving picture display region 210, and may reconstruct a single clip B that covers a part of the two moving pictures.

Also, referring to FIG. 11c, the moving picture editing unit 140 connects the two same editing target moving pictures and may reconstruct a new clip B by joining the two editing target moving pictures.

Here, the editing target moving pictures may be a clip that is generated according to the embodiment of the present invention.

An existing moving picture editing technique focuses on editing a single moving picture, whereas the embodiment of the present invention, in which editing is performed on a clip basis, has an advantage in moving picture editing because various clips covering multiple moving pictures can be generated.

As described above, according to the embodiment of the present invention, after a part to be saved is obtained by editing a moving picture, in other words, after a clip is generated, the clip can be effectively used for editing, for example, the clip can be used as an editing target moving picture; the clip can be connected to a certain part of another editing target moving picture; and a new clip can be generated by connecting multiple clips.

In this case, the moving picture editing unit 140 according to the embodiment of the present invention may perform functions such as copying a clip, deleting a clip, moving a clip, and the like, in the clip display region 230.

The moving picture editing unit 140 can copy a clip displayed in the clip display region 230 and paste it to the next position.

In this case, a user may use various commands to copy the clip in the clip display region 230.

For example, when a long press is input, in other words, when by touch a user selects a clip to be copied and touching of the clip is maintained for a predetermined period of time, the moving picture editing unit 140 copies the corresponding clip.

In this case, just before copying is performed, the moving picture editing unit 140 visually expresses that the corresponding clip is about to be copied, to inform the user of the situation.

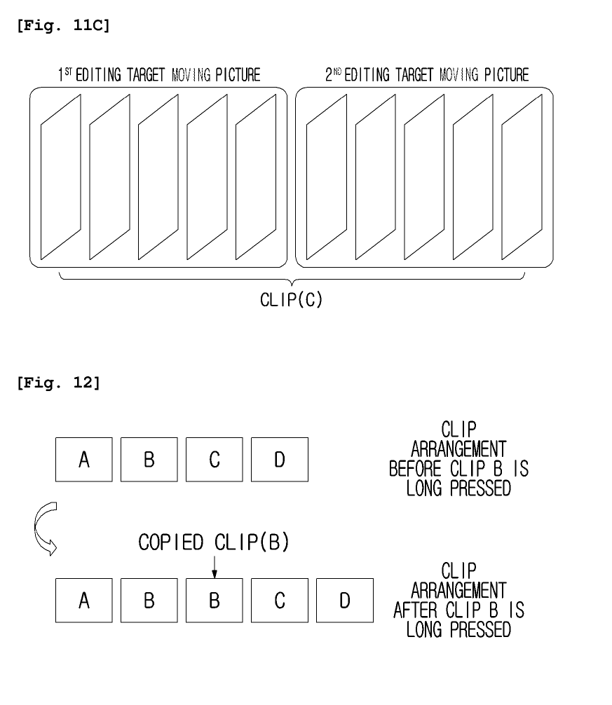

FIG. 12 illustrates an array of clips before and after clip B is long pressed according to an embodiment of the present invention.

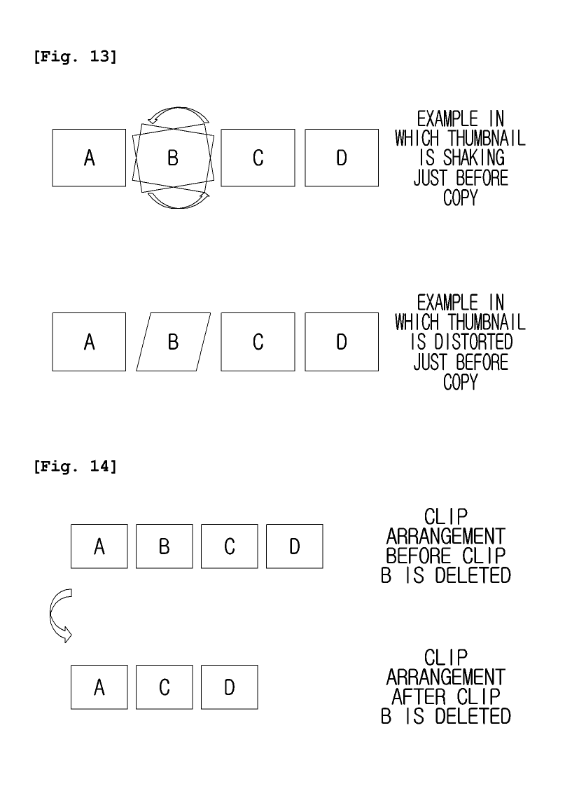

FIG. 13 illustrates a view just before the copy is performed when clip B is long pressed according to an embodiment of the present invention.

In this case, the upper example represents that a thumbnail of the corresponding clip (clip B) is shaking, and the lower example represents that a thumbnail of the corresponding clip (clip B) is distorted.

Also, the moving picture editing unit 140 can move clips arranged in the clip display region 230 to another position. In this case, moving a clip means changing an order of the selected clip and another clip. For example, by selecting any one from among the arranged multiple clips and dragging it to another position, the arrangement position of the clip can be changed.

Also, among clips arranged in the clip display region 230, the moving picture editing unit 140 may delete a certain clip by dragging it to the outside of the touch screen unit 130 in order that the clip is not included in the moving picture of which editing has been completed.

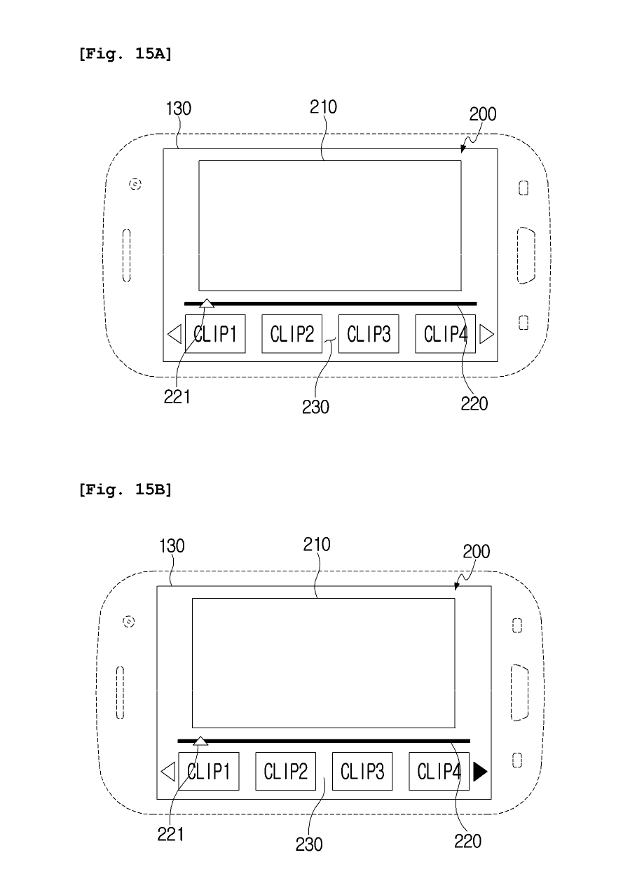

For example, FIG. 14 illustrates an example of the deletion of a clip according to an embodiment of the present invention. In this case, when clip B is deleted, the clips located behind clip B are moved to the position of clip B.

The moving picture editing unit 140 retains only clips that a user want to keep, and may generate a new moving picture by combining the remaining clips according to an order that the user wants.

The moving picture editing unit 140 can perform a preview step before a new moving picture is generated through editing. In this case, a search function separated on a clip basis can be provided for the whole section of the preview.

Generally, when the playing time of a moving picture to be generated is long, a search function is provided by a user command on a progress bar. However, in a portable terminal having a small screen, it is difficult to search a long section of the moving picture only by manipulation of the short progress bar.

In the embodiment of the present invention, the above-mentioned method can be used. However, because a moving picture is formed on a clip basis unlike existing methods, the search can be performed on a clip basis, thus the search can be easily performed on the limited screen. In other words, a clip to be searched is selected, and each section of the selected clip can be searched by easy manipulation.

Hereinabove, the embodiment of the present invention is described, but the present invention is not limited to the above-described embodiment and various modifications are possible.

For example, the UI layout of FIG. 3 according to the embodiment of the present invention is a representative embodiment and is not limited to the embodiment. The UI layout can be variously changed. For example, the moving picture display region 210, the progress bar 220, and the clip display region 230 may change their positions, and the clip can be expressed not by a thumbnail mode but by other methods. Also, the position of a frame that is displayed in the moving picture region 210 can be displayed not using a longitudinal bar but using other forms such as a curved form or a circle.

Also, when the number of generated clips exceeds the number of clips that can be displayed in the clip display region 230, the moving picture editing unit 140 displays arrow marks at the left and right of the clip display region 230 to indicate that hidden clips exist in addition to the displayed clips.

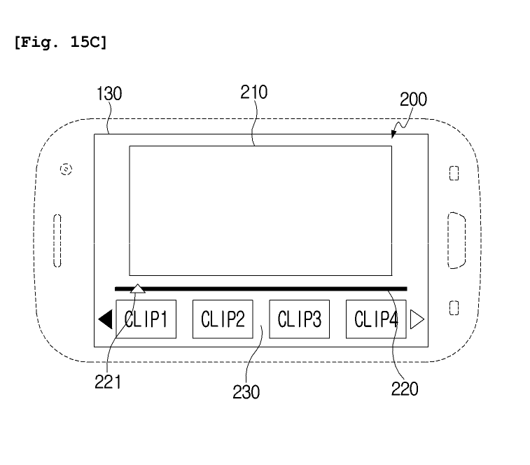

For example, FIG. 15 illustrates a method for displaying whether a hidden clip exists in a clip display region according to an embodiment of the present invention.

Referring to FIG. 15a, if the clip display region 230 has 4 areas for displaying a clip, when the number of the generated clips is less than 4, the arrows at the left and right are disabled.

Also, if the clip display region 230 has 4 areas for displaying a clip, when the number of the generated clips is greater than 4, at least one between the left arrow and the right arrow at the bottom of the screen can be displayed in black to indicate that it is enabled.

In this case, referring to FIG. 15b, when the hidden clips exist at the right of the screen, only the right arrow can be enabled.

Also, referring to FIG. 15c, when the hidden clips exist at the left of the screen, only the left arrow can be enabled.

An embodiment of the present invention may be not only embodied through the above-described apparatus and/or method but also embodied through a program that executes a function corresponding to a configuration of the exemplary embodiment of the present invention or through a recording medium on which the program is recorded and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for editing a moving picture in a portable terminal having a touch screen and a moving picture editing unit, comprising:
a) displaying a user interface (UI), including a moving picture display region, a progress bar, and a clip display region, on the touch screen by executing the moving picture editing unit;
b) displaying an editing target moving picture in the moving picture display region, and generating a clip including frames within a selected section by selecting a start frame and a last frame in the editing target moving picture; and
c) displaying the generated clip in the clip display region, and performing at least one moving picture editing function on a clip basis among copying a clip, moving an order of a clip, and deleting a clip.

2. The method of claim 1, wherein step b) comprises sequentially displaying the frames depending on a drag input that is for selecting a frame in the editing target moving picture by a user

3. The method of claim 1, wherein step b) displays only I-frames of the editing target moving picture and generates the clip based on the I-frames.

4. The method of claim 1, wherein the progress bar displays a time-axis position of a frame in a whole section of the editing target moving picture, using a marker, the frame being displayed in the moving picture display region.

5. The method of claim 4, wherein step b) selects the start frame and the last frame through two frame inputs that are performed by selecting a frame displayed in the moving picture display region and by dragging the selected frame to the clip display region.

6. The method of claim 5, wherein step b) comprises:
changing color of a first marker that indicates a position of a first frame and fixing a position of the first marker when the first frame is input, and displaying a second marker for selecting a second frame; and
deleting the first marker and generating the clip when the second frame is input.

7. The method of claim 6, wherein the first frame is the start frame or the last frame, and the second frame is the start frame or the last frame.

8. The method of claim 1, wherein step b) generates the clip by including frames from the start frame to a frame just before the last frame.

9. The method of claim 8, wherein in step b), when the last frame is either a P-frame or a B-frame, a corresponding I-frame used by the last frame is not included in the generated clip.

10. The method of claim 1, wherein step b) generates a clip that shows a same frame for a certain period of time, by consecutively selecting the same frame.

11. The method of claim 10, wherein step b) generates the clip that shows a same frame for a certain period of time, by selecting the same frame as the start frame and the last frame and then inputting time information between the two frames or inputting the number of frames between the two frames.

12. The method of claim 1, wherein step c) displays a frame image of the generated clip using a thumbnail mode, and displays the frame image as a three-dimensional shape of icon that has length information of the clip.

13. The method of claim 1, wherein step c) copies a first clip located in the clip display region or generates a second clip from a part of frames of the first clip.

14. The method of claim 1, wherein step c) generates multiple clips that share a part of frames.

15. The method of claim 1, wherein step c) comprises:
generating a virtual frame just before the first frame or the right after the last frame of a first editing target moving picture that is displayed in the moving picture display region; and
connecting a second editing target moving picture right before the first frame or right after the last frame by loading the second editing target moving picture through the virtual frame.

16. The method of claim 15, wherein at least one among the first editing target moving picture and the second editing target moving picture is the clip.

17. The method of claim 16, further comprising,
reconstructing a progress bar based on the connected first editing target moving picture and second editing target moving picture after the step for connecting the second editing target moving picture.

18. The method of claim 16, further comprising, after the step for connecting the second editing target moving picture:
generating a clip by joining the first editing target moving picture and the second editing target moving picture; or
generating a clip covering a part of the first editing target moving picture and a part of the second editing target moving picture.

19. The method of claim 1, wherein step c) performs a preview step before generating a moving picture that includes multiple clips, and provides a search function for each of the clips.

20. A portable terminal, which stores a program implementing the method of claim 1, or in which a recording medium storing the program can be mounted.

21. A recording medium in which a program for implementing the method of claim 1 is stored.
